(19) United States
(12) Patent Application Publication
(10) Pub. No.: US 2021/0402836 A1
(43) Pub. Date: Dec. 30, 2021

(54) TRAILER HITCH BALL MOUNT

(71) Applicant: FORCOME (ZHEJIANG) CO., LTD., Jinhua (CN)

(72) Inventor: Jiancheng WANG, Jinhua (CN)

(21) Appl. No.: 16/940,691

(22) Filed: Jul. 28, 2020

(30) Foreign Application Priority Data
Jun. 28, 2020 (CN) 202030335268.7

(51) Int. Cl. B60D 1/06; C22C 21/14; C22C 21/08; C22C 21/06; C22C 21/10; C22C 21/16

(52) U.S. Cl. CPC B60D 1/065; C22C 21/14; C22C 21/16; C22C 21/06; C22C 21/10; C22C 21/08

(57) ABSTRACT

A trailer hitch ball mount includes: a hitch portion that has a square tubular shape; a ball portion; and a bridging portion that connects the hitch portion and the ball portion. The ball portion includes a first rectangular recess on a top surface of the ball portion; two parallel first side walls are formed at two parallel sides of the first rectangular recess, and other two parallel sides of the first rectangular recess are open; the bridging portion has a streamlined contour; and the trailer hitch ball mount comprises an aluminum alloy.

The present invention claims priority to Chinese Patent Application No. 202030335268.7, filed on Jun. 28, 2020, which is incorporated by reference for all purposes as if fully set forth herein.

### FIELD OF THE INVENTION

The present invention relates to a trailer hitch ball mount.

### BACKGROUND OF THE INVENTION

A trailer hitch ball mount offers a connection between a vehicle and a trailer. The trailer hitch ball mount is attached to the vehicle and typically includes a hitch ball positioned at a certain height off the ground to engage a tongue of the trailer. A coupler at the end of the trailer tongue fits over the hitch ball and locks into place, allowing the vehicle and trailer to pivot in relation to each other.

Trailer hitch ball mounts are traditionally made of steel for the strength needed. The individual components of the trailer hitch ball mounts are fabricated separately and then welded together. This leads some undesirable features, i.e., heavy weights, steel rusts, difficulties to attach the ball mounts to and to remove the ball mounts from hitch adapters.

There is a need for durable, light, and easy to operate trailer hitch ball mounts.

### SUMMARY OF THE INVENTION

In one embodiment, a trailer hitch ball mount includes: a hitch portion that has a square tubular shape; a ball portion; and a bridging portion that connects the hitch portion and the ball portion. The ball portion includes a first rectangular recess on a top surface of the ball portion; two parallel first side walls are formed at two parallel sides of the first rectangular recess, and other two parallel sides of the first rectangular recess are open; the bridging portion has a streamlined contour; and the trailer hitch ball mount comprises an aluminum alloy.

In another embodiment, the parallel first side walls have a height of 4-6 mm.

In another embodiment, the first rectangular recess has a size of 41-43 mm×50-53 mm.

In another embodiment, the ball portion further includes a second rectangular recess on a bottom surface of the ball portion; two parallel second side walls are formed at two parallel sides of the second rectangular recess, and other two parallel sides of the second rectangular recess are open;

In another embodiment, the parallel second side walls have a height of 4-6 mm.

In another embodiment, the second rectangular recess has a size of 41-43 mm×50-53 mm.

In another embodiment, the trailer hitch ball mount consists of the aluminum alloy.

In another embodiment, the aluminum alloy comprises 99.6 wt % of Al; 93.7 wt % of Al, 5.5 wt % of Cu, 0.4 wt % of Bi, and 0.4 wt % of Pb; 93.5 wt % of Al, 4.4 wt % of Cu, 0.8 wt % of Si, 0.8 wt % of Mn, and 0.5 wt % of Mg; 93.5 wt % of Al, 4.4 wt % of Cu, 0.6 wt % of Mn, and 1.5 wt % of Mg; 98.6 wt % of Al, 1.5 wt % of Mn, and 0.12 wt % of Cu; 97.8 wt % of Al, 1.2 wt % of Mn, and 1.0 wt % of Mg; 98.6 wt % of Al, and 1.4 wt % of Mg; 96.2 wt % of Al, 3.5 wt % of Mg, and 0.25 wt % of Cr; 97.9 wt % of Al, 0.6 wt % of Si, 1.0 wt % of Mg, 0.25 wt % of Cu, and 0.2 wt % of Cr; 96.4 wt % of Al, 2.7 wt % of Mg, 0.8 wt % of Mn, 0.12 wt % of Cr; 94.0 wt % of Al, 5.1 wt % of Mg, 0.8 wt % of Mn, 0.12 wt % of Cr; 95.7 wt % of Al, 1.4 wt % of Si, 1.1 wt % of Mg, 0.8 wt % of Mn, and 1.0 wt % of Cu; 96.8 wt % of Al, 0.6 wt % Si, 1.0 wt % of Mg, 0.25 wt % of Cu, 0.1 wt % of Cr, 0.6 wt % of Bi, and 0.6 wt % of Pb; 89.0 wt % of Al, 6.2 wt % of Zn, 2.3 wt % of Mg, 2.3 wt % of Cu, and 0.1 wt % of Zr; 98.0 wt % of Al, 1.5 wt % of Fe, and 0.5 wt % of Mn; or 98.2 wt % of Al, 1.4 wt % of Fe, and 0.4 wt % of Mn.

In another embodiment, the aluminum alloy comprises 97.9 wt % of Al, 0.6 wt % of Si, 1.0 wt % of Mg, 0.25 wt % of Cu, and 0.2 wt % of Cr.

In another embodiment, the aluminum alloy has an anodized surface.

In another embodiment, the trailer hitch ball mount has a weight of 1.75 kg to 2.15 kg.

In another embodiment, the trailer hitch ball mount has a weight of 1.75 kg, 1.93 kg, or 2.15 kg.

In another embodiment, the trailer hitch ball mount has a gross trailer weight of up to 8,000 lbs.

In another embodiment, the trailer hitch ball mount has a tongue weight of up to 800 lbs.

In another embodiment, the ball portion has a square tubular shape.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows the trailer hitch ball mount of the present invention in a perspective view.

FIG. 2 shows the trailer hitch ball mount of the present invention in a side view.

FIG. 3 shows the trailer hitch ball mount of the present invention with a notched trailer hitch ball with bolt and a nut in a perspective view.

FIG. 4 shows the trailer hitch ball mount of the present invention with a trailer hitch ball with bolt, a washer, and a nut in a perspective view.

FIG. 5 shows the ball portion of the trailer hitch ball mount in a side view and a top view.

In the figures, reference numerals are defined as follows: 10. a trailer hitch ball mount, 11. a hitch portion, 12. a ball portion, 13. a bridging portion, 14. a locking pin hole, 15. a hitch ball hole, 21. a top surface of the ball portion, 22. a first recess, 23. parallel first side walls, 24. a bottom surface of the ball portion, 25. a second recess, 26. parallel second side walls, 31. a notched trailer hitch ball, 32. a bolt, 33. a nut, 34. a trailer hitch ball, 35. a bolt, 36. a nut, and 37. a washer.

### DETAILED DESCRIPTION OF THE ILLUSTRATED EMBODIMENTS

Reference will now be made in detail to embodiments of the present invention, example of which is illustrated in the accompanying drawings.

In the description of the present application, it is necessary to understand that the terms “center,” “top,” “bottom,” “left,” “right,” “vertical,” “horizontal,” “inside,” “outside,” “bottom,” “top” and other indicative orientation or position relations are based on the orientation or position relations shown in the drawings. This is intended only for the convenience of describing and simplifying the description of the present application, and is not intended to indicate or imply that the device or element referred to must have a specific orientation, or be constructed and operated in a specific orientation, and therefore cannot be understood as a limitation on the new form of the utility.

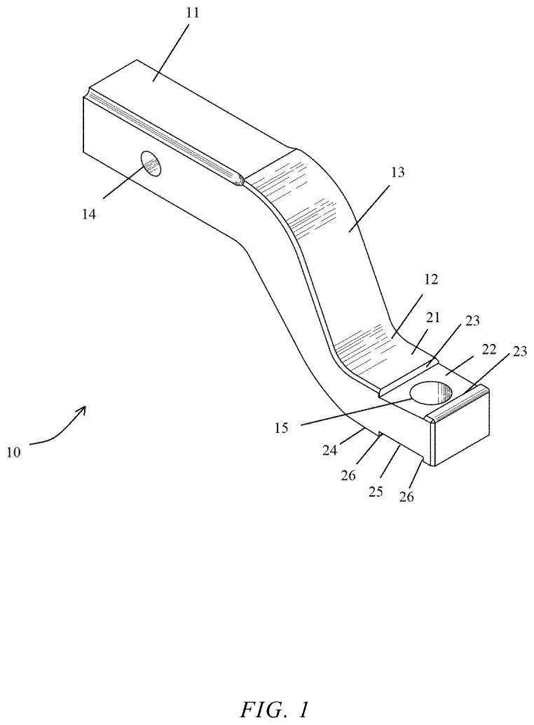

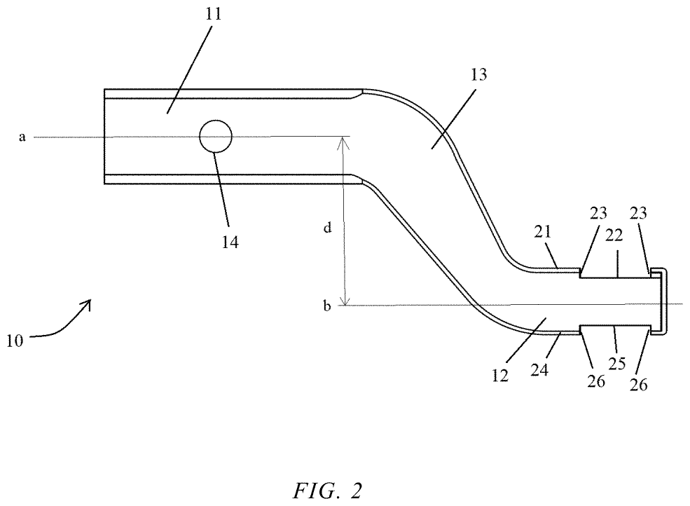

As shown in FIGS. 1 and 2, a trailer hitch ball mount 10 includes: a hitch portion 11, a ball portion 12, and a bridging portion 13. The hitch portion 11 has a square tubular shape and includes a locking pin hole 14. The hitch portion 11 is sized to be received in a sleeve of a hitch receiver on a vehicle. The cross section of the hitch portion 11 is a square. The size of the square is preferably two inches (2×2) or one-half inches (1.5×1.5). When the hitch portion 11 is received into the hitch receiver, a pin is inserted through the hitch receiver and the locking pin hole 14 to securely connect the hitch portion 11 and the hitch receiver.

The ball portion 12 can also have a square tubular shape. The ball portion 12 has a top surface 21 and a bottom surface 24. The top surface 21 includes a first rectangular recess 22. Two parallel first side walls 23 are formed at two parallel side of the first rectangular recess 22. Other two parallel sides of the first rectangular recess 22 are open. The bottom surface 24 includes a second rectangular recess 25. Two parallel second side walls 26 are formed at two parallel side of the second rectangular recess 25. Other two parallel sides of the second rectangular recess 25 are open.

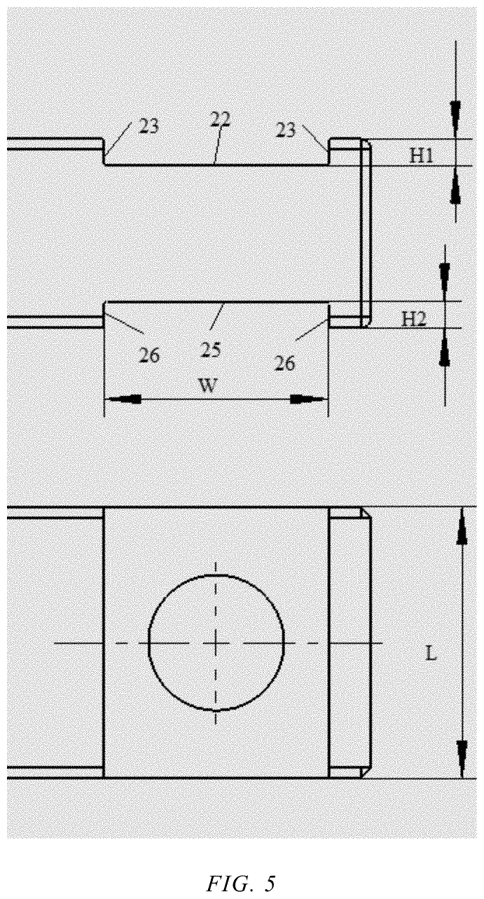

As shown in FIG. 5, the parallel first side walls 23 has a height “H1.” The height “H1” is 4-6 mm, preferably 5 mm. The parallel second side walls 26 has a height “H2.” The height “H2” is 4-6 mm, preferably 5 mm. The first rectangular recess 22 and the second rectangular recess 25 have the same size and are superimposed in a top view. The first rectangular recess 22 and the second rectangular recess 25 have a length “L” and a width “W.” The length “L” is 50-53 mm, preferably, 50.8 mm, and the width “W” is 41-43 mm, preferably 42 mm.

The ball portion 12 includes a hitch ball hole 15. The hitch ball hole is located in the center of the first rectangular recess 22 and the second rectangular recess 25. The hitch ball hole 15 can be sized accordance with the hitch balls to be used with the trailer hitch ball mount 10. In a preferred embodiment, the hitch ball hole 15 has a diameter of about 1 inch.

The bridging portion 13 connects the hitch portion 11 and ball portion 12. The bridging portion 13 has a streamlined contour. As shown in FIG. 2, a longitudinal axis (a) of the hitch portion 11 is parallel to a longitudinal axis “b” of the ball portion 12. A distance between the longitudinal axis “a” of the hitch portion 11 and the longitudinal axis “b” of the ball portion 12 is “d.” The distance “d” is 2-6 inches. The distance “d” can be, for example, 2 inches, 4, inches, or 6 inches.

The trailer hitch ball mount 10 can be made by an extrusion process from an aluminum alloy. In a preferred embodiment, the trailer hitch ball mount 10 is made of only an aluminum alloy. The aluminum alloy can be a an aluminum alloy that includes 99.6 wt % of Al; 93.7 wt % of Al, 5.5 wt % of Cu, 0.4 wt % of Bi, and 0.4 wt % of Pb; 93.5 wt % of Al, 4.4 wt % of Cu, 0.8 wt % of Si, 0.8 wt % of Mn, and 0.5 wt % of Mg; 93.5 wt % of Al, 4.4 wt % of Cu, 0.6 wt % of Mn, and 1.5 wt % of Mg; 98.6 wt % of Al, 1.5 wt % of Mn, and 0.12 wt % of Cu; 97.8 wt % of Al, 1.2 wt % of Mn, and 1.0 wt % of Mg; 98.6 wt % of Al, and 1.4 wt % of Mg; 96.2 wt % of Al, 3.5 wt % of Mg, and 0.25 wt % of Cr; 97.9 wt % of Al, 0.6 wt % of Si, 1.0 wt % of Mg, 0.25 wt % of Cu, and 0.2 wt % of Cr; 96.4 wt % of Al, 2.7 wt % of Mg, 0.8 wt % of Mn, 0.12 wt % of Cr; 94.0 wt % of Al, 5.1 wt % of Mg, 0.8 wt % of Mn, 0.12 wt % of Cr; 95.7 wt % of Al, 1.4 wt % of Si, 1.1 wt % of Mg, 0.8 wt % of Mn, and 1.0 wt % of Cu; 96.8 wt % of Al, 0.6 wt % Si, 1.0 wt % of Mg, 0.25 wt % of Cu, 0.1 wt % of Cr, 0.6 wt % of Bi, and 0.6 wt % of Pb; 89.0 wt % of Al, 6.2 wt % of Zn, 2.3 wt % of Mg, 2.3 wt % of Cu, and 0.1 wt % of Zr; 98.0 wt % of Al, 1.5 wt % of Fe, and 0.5 wt % of Mn; or 98.2 wt % of Al, 1.4 wt % of Fe, and 0.4 wt % of Mn.

In a preferred embodiment, the aluminum alloy includes 97.9 wt % of Al, 0.6 wt % of Si, 1.0 wt % of Mg, 0.25 wt % of Cu, and 0.2 wt % of Cr.

In a preferred embodiment, the aluminum alloy has an anodized surface.

In a preferred embodiment, the trailer hitch ball mount 10 has a weight of 1.75 kg to 2.15 kg, for example, 1.75 kg, 1.93 kg, or 2.15 kg.

Gross trailer weight is the weight of the trailer fully loaded. The trailer hitch ball mount 10 can used to tow a trailer that has a gross trailer weight of up to 8,000 lbs.

Tongue weight is the downward force that is exerted on the hitch ball by the coupler. The tongue weight will vary depending on where the load is positioned in relationship to the trailer axles. The trailer hitch ball mount 10 has a tongue weight of up to 800 lbs.

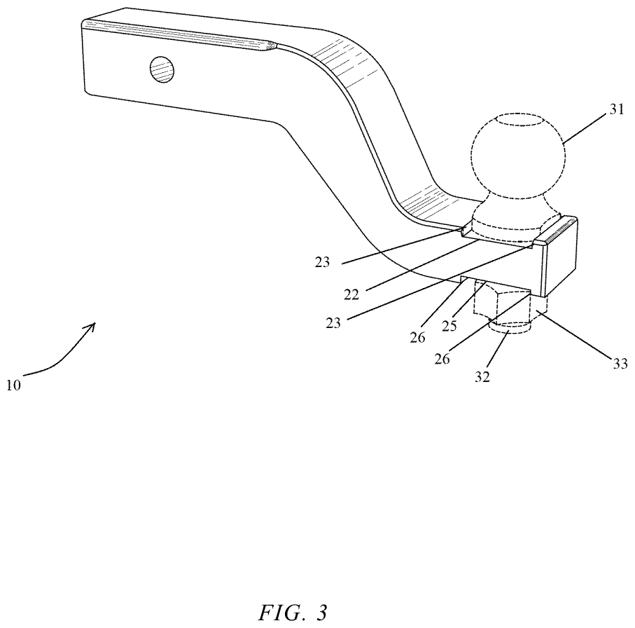

As shown in FIG. 3, the trailer hitch ball mount 10 can be used with a notched trailer hitch ball 31 and a nut 33. The notched trailer hitch ball 31 includes a bolt 32, and the bolt 32 has a diameter that is the same as or smaller than the diameter of the hitch ball hole 15. The notched trailer hitch ball 31 has a notched part that has a same width as the width “W” of the first rectangular recess 22.

The bolt 32 is inserted into the hitch ball hole 15. The notched trailer hitch ball 31 fits snugly in the first rectangular recess 22. The parallel first side walls 23 engage the notched part of the notched trailer hitch ball 31 to lock the notched trailer hitch ball 31. A user can easily use a wrench to tight the nut 33 to the bolt 32 to securely connect the notched trailer hitch ball 31 to the trailer hitch ball mount 10. No special tool will be needed. The trailer hitch ball mount 10 can also be rotated 180 degree. The notched trailer hitch ball 31 then fits snugly in the second rectangular recess 25. This makes the trailer hitch ball mount 10 versatile and can be used in two different ways to accommodate trailers with different heights.

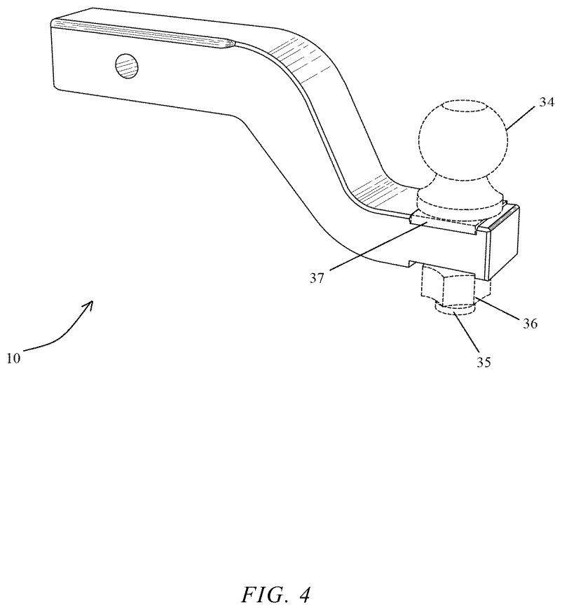

As shown in FIG. 4, the trailer hitch ball mount 10 can also be used with a regular trailer hitch ball 34 and a nut 36. Because the trailer hitch ball 34 does not have a notched port, it does not fit in the first rectangular recess 22. A washer 37 is first placed in the first rectangular recess 22. The washer 37 has a thickness that is the same as the height “H1” of the parallel first side walls 23. The top surface of the ball portion 21 is then flat.

The trailer hitch ball 34 includes a bolt 35. The bolt 35 is inserted into the hitch ball hole 15. A user can tight the nut 36 to the bolt 35 to securely connect the notched trailer hitch ball 31 to the trailer hitch ball mount 10. Again, the trailer hitch ball mount 10 can also be rotated 180 degree. The washer 37 is first placed in the second rectangular recess 25. The bottom surface of the ball portion 21 is then flat. The user can the tight the nut 36 to the bolt 35 to securely connect the notched trailer hitch ball 31 to the trailer hitch ball mount 10. This makes the trailer hitch ball mount 10 versatile and can be used in two different ways to accommodate trailers with different heights.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A trailer hitch ball mount comprising:
a hitch portion that has a square tubular shape;
a ball portion; and
a bridging portion that connects the hitch portion and the ball portion,
wherein the ball portion includes a first rectangular recess on a top surface of the ball portion;
wherein two parallel first side walls are formed at two parallel sides of the first rectangular recess, and other two parallel sides of the first rectangular recess are open;
wherein the bridging portion has a streamlined contour; and
wherein the trailer hitch ball mount comprises an aluminum alloy.

2. The trailer hitch ball mount of claim 1, wherein the parallel first side walls have a height of 4-6 mm.

3. The trailer hitch ball mount of claim 1, wherein the first rectangular recess has a size of 41-43 mm×50-53 mm.

4. The trailer hitch ball mount of claim 1, wherein the ball portion further includes a second rectangular recess on a bottom surface of the ball portion; two parallel second side walls are formed at two parallel sides of the second rectangular recess, and other two parallel sides of the second rectangular recess are open;

5. The trailer hitch ball mount of claim 4, wherein the parallel second side walls have a height of 4-6 mm.

6. The trailer hitch ball mount of claim 4, wherein the second rectangular recess has a size of 41-43 mm×50-53 mm.

7. The trailer hitch ball mount of claim 1, wherein the trailer hitch ball mount consists of the aluminum alloy.

8. The trailer hitch ball mount of claim 1, wherein the aluminum alloy comprises
99.6 wt % of Al;
93.7 wt % of Al, 5.5 wt % of Cu, 0.4 wt % of Bi, and 0.4 wt % of Pb;
93.5 wt % of Al, 4.4 wt % of Cu, 0.8 wt % of Si, 0.8 wt % of Mn, and 0.5 wt % of Mg;
93.5 wt % of Al, 4.4 wt % of Cu, 0.6 wt % of Mn, and 1.5 wt % of Mg;
98.6 wt % of Al, 1.5 wt % of Mn, and 0.12 wt % of Cu;
97.8 wt % of Al, 1.2 wt % of Mn, and 1.0 wt % of Mg;
98.6 wt % of Al, and 1.4 wt % of Mg;
96.2 wt % of Al, 3.5 wt % of Mg, and 0.25 wt % of Cr;
97.9 wt % of Al, 0.6 wt % of Si, 1.0 wt % of Mg, 0.25 wt % of Cu, and 0.2 wt % of Cr;
96.4 wt % of Al, 2.7 wt % of Mg, 0.8 wt % of Mn, 0.12 wt % of Cr;
94.0 wt % of Al, 5.1 wt % of Mg, 0.8 wt % of Mn, 0.12 wt % of Cr;
95.7 wt % of Al, 1.4 wt % of Si, 1.1 wt % of Mg, 0.8 wt % of Mn, and 1.0 wt % of Cu;
96.8 wt % of Al, 0.6 wt % Si, 1.0 wt % of Mg, 0.25 wt % of Cu, 0.1 wt % of Cr, 0.6 wt % of Bi, and 0.6 wt % of Pb;
89.0 wt % of Al, 6.2 wt % of Zn, 2.3 wt % of Mg, 2.3 wt % of Cu, and 0.1 wt % of Zr;
98.0 wt % of Al, 1.5 wt % of Fe, and 0.5 wt % of Mn; or
98.2 wt % of Al, 1.4 wt % of Fe, and 0.4 wt % of Mn.

9. The trailer hitch ball mount of claim 8, wherein the aluminum alloy comprises 97.9 wt % of Al, 0.6 wt % of Si, 1.0 wt % of Mg, 0.25 wt % of Cu, and 0.2 wt % of Cr;

10. The trailer hitch ball mount of claim 1, wherein the aluminum alloy has an anodized surface.

11. The trailer hitch ball mount of claim 1, wherein the trailer hitch ball mount has a weight of 1.75 kg to 2.15 kg.

12. The trailer hitch ball mount of claim 1, wherein the trailer hitch ball mount has a weight of 1.75 kg, 1.93 kg, or 2.15 kg.

13. The trailer hitch ball mount of claim 1, wherein the trailer hitch ball mount has a gross trailer weight of up to 8,000 lbs.

14. The trailer hitch ball mount of claim 1, wherein the trailer hitch ball mount has a tongue weight of up to 800 lbs.

15. The trailer hitch ball mount of claim 1, wherein the ball portion has a square tubular shape.
